(19) United States
(12) Patent Application Publication
(10) Pub. No.: US 2003/0074487 A1
(43) Pub. Date: Apr. 17, 2003

(54) Dynamic operating system

(76) Inventors: Tankut Akgul, Eskisehir (TR); Pramote Kuacharoen, Trang (TH); Vincent J. Mooney III, Decatur, GA (US); Vijay K. Madisetti, Marietta, GA (US)

Correspondence Address: Nora M. Tocups, Law Office of Nora M. Tocups, 140 Pinecrest Avenue, P.O. Box 698, Decatur, GA, 30031-0698, US

(21) Appl. No.: 10/272,884

(22) Filed: Oct. 17, 2002

Related U.S. Application Data
(60) Provisional application No. 60/329,903, filed on Oct. 17, 2001.

(51) Int. Cl. G06F 9/46; G06F 9/00

(52) U.S. Cl. 709/328; 709/331

(57) ABSTRACT

Linking of a new or updated module to an operating system without affecting other modules, and without reboot or recompilation. A core module includes a table of locations of application program interfaces of other modules. A selected module is linked to the core module. Specifically, the module is initialized and provided with a pointer to the core module's table. The table is provided with an address of the APIs of the module. The other modules are unaffected by the linking because they are not provided with the address of the module. A reboot or recompilation of the operating system is unnecessary because the other modules are unaffected. Nevertheless, the other modules have access to the APIs of the module and to each others' APIs through the core module. The other modules include a pointer to the core module's table to access the

### RELATED APPLICATION

This application claims priority to and the benefit of the prior filed co-pending and commonly owned patent application, which has been assigned U.S. patent application Ser. No. 60/329/903, which is entitled “Dynamic Real-Time Operating System,” filed on Oct. 17, 2001, and which is incorporated herein by this reference.

### FIELD OF THE INVENTIONS

The inventions relate to operating systems of computers, and particular relate to the installation and updating of kernel modules in an operating system as well as the invocation of applications programming interfaces (APIs) between and among the kernel modules.

### BACKGROUND

Existing operating systems (OSes) provide fixed interfaces and implementations of services and resources. The OS services are provided typically as a set of modules or libraries. In embedded systems, the OS and an application are usually compiled together. The services needed for the application are selected by simply setting flags at the time of the OS and application build. As a result, this standard OS compilation methodology prevents updating the application of the OS at runtime. However, future embedded systems are likely to include a multitude of applications, some subset of which changes every few months (or possibly every few weeks in some cases).

Even if a static OS were to include all possible services, the OS would likely become inefficient and insufficient for emerging applications. A static OS cannot efficiently support a wide range of applications with different service demands. For example, a priority-based scheduler is suitable for applications where the deadline of the highest-priority task is the most important. This scheduler, however, does not work well in scheduling network packets such as video-on-demand and streamed audio, where predictable quality of service is required. In order to support these applications, the OS must be rewritten, recompiled and loaded to the device. Fortunately, today's embedded systems tend to support applications of a single type, e.g., voice or multimedia. However, tomorrow's embedded devices will surely be much more diverse in the applications set to be supported.

With the rapid growth of the embedded industry, applications such as cellular phones and personal digital assistants require more and more functionality in order to sell in high volumes. Third generation cellular phones will also be upgradeable over the air to allow more internal features to be added without the need for physically going to a store. To support new features efficiently, the OS kernel modules must be updateable at runtime.

An operating system which enables system services to be defined in an application-specific fashion offers finer-grained control over a machine's resources to an application through runtime adaptation of the system to application requirements. The services are efficient in both functionalities and performance for the application. These services come with applications and are loaded when the applications need them. This requires a modular design of the OS. To provide modularity and performance, operating system kernels should have only minimal embedded functionality.

U.S. Pat. No. 5,359,730 to Marron entitled “Method of Operating a Data Processing System Having a Dynamic Software Update Facility” describes a method for replacing old operating system programs or modules with new updated versions. The new versions are loaded into the system with change instructions providing information controlling the update. Kernel modules may be updated at runtime. Dynamic functionality, among others, is not a part of the operating system.

U.S. Pat. No. 5,666,293 to Metz et al. entitled “Downloading Operating System Software through a Broadcast Channel” describes a method for downloading and installing an operating system. The method includes periodic upgrading of the operation of set-top terminals, which requires upgrading the software, particularly the operating system. For installation, the network carries a cyclic broadcast of a packet data file containing the operating system. After the operating system is downloaded, the system halts the current operating system and reboots the system with the downloaded operating system. Dynamic functionality, among others, is not a part of the operating system. Another disadvantage is that the system has to be rebooted after download.

U.S. Pat. No. 6,066,182 to Wilde et al. entitled “Method and Apparatus for Operating System Personalization during Installation” describes operating system installation. Personalization parameters are provided for an automated operating system installation on a computer system. The operating system, however, can only be configured during installation using personalization parameters, and thus cannot be dynamically updated at runtime.

U.S. Pat. No. 6,272,519 to Shearer et al. entitled “Dynamic Alteration of Operating System Kernel Resource Tables,” describes a method to dynamically alter the availability or characteristics of specified system resources such as inter-process communications facilities or tuning variables that control operating efficiency. The method allows the modification of system resources without the need to rebuild and reinitialize the operating system. The alteration is performed by replacing the entries in the operating system's system call table by function pointers. The entries in the system call table are affiliated with the target resource. The technique is known as “hooking” or “intercepting” the system call. When the system function call is invoked, the intercept function runs its own code and then branches to the originally called system function where normal kernel processing proceeds. Upon completion, the called system function returns to the hooked function to allow any required post-processing. The method does not dynamically update or delete the kernel modules since the intercept functions are pre-processing and post-processing function for the old kernel module.

In sum, there is a need for methods and systems that install and update an operating system on a dynamic, flexible, and extensible basis. There is also a need for methods and systems that dynamically install and update an operating system in run-time or real-time. There is a further need for methods and systems that dynamically install and update an operating system and that do not require a reboot or recompilation of the operating system. Moreover, there is a need for methods and systems that dynamically install and update an operating system that supports a wide range of applications and that allows for specific operating system configurations depending on the applications in use.

### SUMMARY

Stated generally, the inventions provide a dynamic operating system that efficiently supports a wide range of applications. The inventions include an operating system having a kernel with modules. The kernel modules allow for a flexible, easily extensive operating system. The operating system may be dynamically loaded at runtime with selected modules to exactly suit the applications without necessitating a reboot or recompilation of the system. Kernel services can be specific to each application. System resources are saved by having only the necessary modules loaded. The dynamic OS is adaptable, including all parts of the kernel, even the part responsible for dynamic installation of new kernel modules! Therefore, the resource requirements of current and future embedded applications can be met by the dynamic operating system of the inventions. A bug fix in one of the modules or integration of a new or updated version of a module can be accomplished without reboot or recompilation of the whole system.

The operating system may initially boot up with default kernel modules. When one of the default modules needs to be updated, the module loader loads the requested module from a storage device into memory. The storage device may be located locally or remotely. When the requested module is in memory, the loader checks whether or not the current module is in a safe state for removing. If the current module is in a safe state, the new or updated module is initialized. During initialization, the new or updated module registers the module with the kernel. Data from the current module may be transferred to the new or updated module. After initialization, the new or updated module is ready to provide kernel services and the old module can be removed from memory.

In particular, in an exemplary embodiment, an operating system includes a kernel with modules. The modules include a core and other modules. A new or updated module may be linked to the operation of the operating system without affecting the other modules of the kernel, and without a reboot or a recompilation of the operating system.

In the exemplary embodiment, the core module includes a table. Each entry in the table respectively represents a location of at least an application program interface (API) or APIs of one of the other modules. If a new or updated module is selected for use with the operating system, the new or updated module may be loaded into memory if it is not already included. The new or updated module is linked to the operation of the operating system by linking the new or updated module to the core module. Specifically, the new or updated module is initialized and is provided with a pointer to the table of the core module. Further, the table of the core module is provided with an entry representing the address of at least an API or APIs of the new or updated module. The address may be provided by the new or updated module to the core module for inclusion in an entry in the table.

This exemplary embodiment provides for the updating of a “running” or old module with an updated or new module. After the old module is no longer needed, it may be unlinked and may be deleted from memory. Alternatively, the old module may be cascaded with the new module. By the cascade, the new module invokes the old module when the new module is invoked. To carry out the invocation, the new module may store the location of the API or APIs of the old module.

In this exemplary embodiment, the other modules of the kernel are unaffected by the linking of the new or updated module to the operation of the operating system because the other modules are not provided with the address of the API or APIs of the new or updated module. A reboot or recompilation of the operating system is unnecessary at least because the other modules of the kernel are unaffected by the linking of the new or updated module. Nevertheless, the other modules have access to the API or APIs of the new or updated module and to each others API or APIs. Each of the other modules includes a pointer to the table of the core module so that each may access the API or APIs of the new or updated module or of each other. For example, a first module may invoke a second module. To do so, the first module uses its pointer to the table of the core module to obtain the location of the API or APIs of the second module from the core module. The first module then uses the location information obtained from the core module to invoke the second module.

Advantageously, the inventions provide methods and systems that install and update an operating system on a dynamic, flexible, and extensible basis. The inventions dynamically install and update an operating system in run-time or real-time. The inventions dynamically install and update an operating system that does not require a reboot or recompilation of the operating system. Moreover, the inventions dynamically install and update an operating system that supports a wide range of applications and that allows for specific operating system configurations depending on the applications in use.

### BRIEF DESCRIPTION OF THE DRAWINGS

FIG. 1 illustrates exemplary layers of a computer system.

FIG. 2 shows the structure of an exemplary kernel module.

FIG. 3 shows the structure of an exemplary core kernel.

FIG. 4 illustrates an exemplary installation process of a task module.

FIG. 5 is an exemplary piece of C source code illustrating how to invoke an exemplary scheduler API to schedule a new task.

FIG. 6 shows the exemplary updating of an existing kernel module by reusing the existing kernel module.

FIG. 7 illustrates an exemplary module invocation process using pointers.

FIG. 8 is a flow chart explaining exemplary module updating.

FIG. 9 is a flow chart explaining the switching process from an exemplary priority-based scheduler to an exemplary round-robin scheduler.

FIG. 10 is a screen shot of an exemplary simulation showing task 1 running under a priority-based scheduler.

FIG. 11 is a screen shot of an exemplary simulation showing task 3 running under a priority-based scheduler.

FIG. 12 is a screen shot of an exemplary simulation showing all tasks taking turns under a round-robin scheduler.

### DETAILED DESCRIPTION

Several exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views. As utilized in the description herein and throughout the claims that follow, the meaning of “a,” “an,” and “the” include plural references also, unless the context of use clearly dictates otherwise. Additionally, the meaning of “in” includes “in” and “on” unless the context clearly dictates otherwise as the term is utilized in the description herein and throughout the claims that follow.

Generally stated, the inventions include embodiments for runtime installation and updating of kernel modules of a dynamic operating system. Advantageously, any kernel module of the operating system can be dynamically loaded at runtime without necessitating a reboot or recompilation of the system. Moreover, the other modules of the operating system are unaffected by the loading of the new or updated module. Each of the modules of the operating system may invoke any of the other modules as is explained below.

The environment in which the inventions are used encompasses embedded systems. Examples of embedded devices are cellular phones and handheld devices. The storage device for the kernel modules may be a local storage device such as local disk drive, flash ROM, CD ROM; and/or a remote storage device such as a network disk drive over a wire or wireless link.

As is discussed in detail below, the disclosed exemplary methods, systems and apparatus for runtime updating of a dynamic operating system is implemented, simulated and tested using a hardware/software co-simulation tool and an evaluation board. The inventions, however, are contemplated for use on any other embedded devices or any general purpose computers.

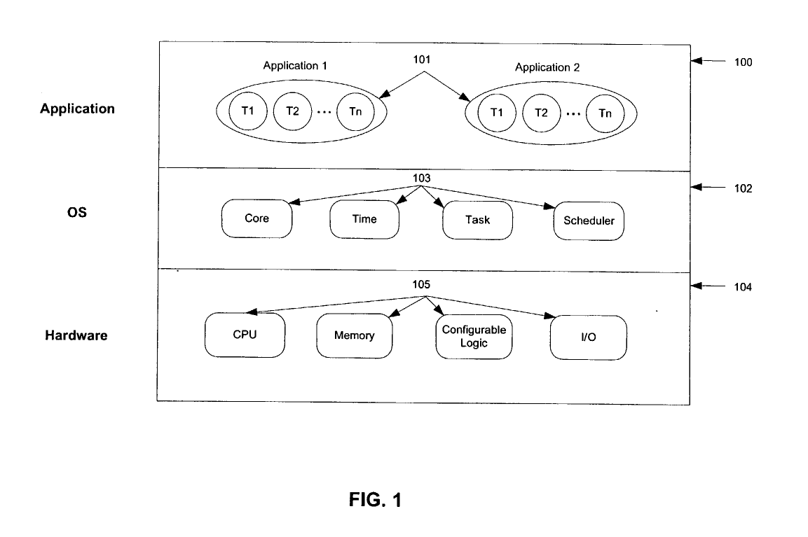

As illustrated in FIG. 1, a simplistic view of an exemplary computer system including three layers, namely, application layer 100, operating system (OS) layer 102, and hardware layer 104. The OS layer 102 may also be referred to herein as the OS layer. Application layer 100 may have one or more applications 101. Each application may be single-threaded or multithreaded. In other words, each application may have one or more tasks running concurrently. An application may invoke kernel services through system calls provided by the OS layer 101. The OS layer 101 contains a kernel with modules 103 such as core, time, task, and scheduler modules. A module may be referred to herein as a kernel module. The OS layer 101 interfaces with and manages application layer 100 and hardware layer 104. Hardware layer 104 may consist of hardware components 105 such as central processing unit (CPU), memory, configurable logic and input/output (I/O).

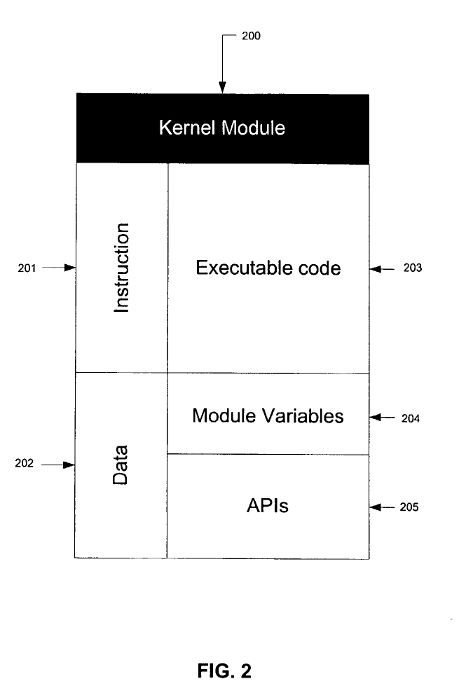

An exemplary kernel module 200 structure is shown in FIG. 2. The kernel module 200 includes an instruction section 201 (also referred to as text section), and data section 202. The instruction section 201 contains executable code 203. The data section 202 contains module variables 204 and APIs 205. Therefore, switching of one module with another consists of changing both the instruction section 201 and the data section 202 in the kernel space 102 (also referred to herein as the OS layer of the computer system). This switching requires dynamic linking of a new or updated instruction section 201 and new or updated data section 202 into the kernel space 102. The appropriate modules for supporting an application are integrated into the operating system (OS) and unneeded modules can be removed from the OS at runtime.

In the exemplary embodiment, a module may be installed anywhere in the kernel space 102. Therefore, absolute address references to the module's variables are not feasible. The executable code must be position independent. In order to implement position independent code (PIC) without modifying the compiler, the module global variables are aggregated into one structure. In other words, a structure such as a table is provided that includes entries. Each entry represents a location or an address of APIs of a module. In the exemplary embodiment, the single structure such as a table is included in the core module of the kernel of the operating system. As a result, the operating system has only one structure containing global variables, and this structure is included in the core module. Therefore, runtime linking of modules can be done with a few instructions. The base address of the global variables is located in the module global offset table, which is installed during module initialization. The module also has APIs that allow other modules or applications to access its internal data or services. The APIs are also put into a structure. The address of the API structure is linked to the kernel and can be accessed by other modules. Thus, updating a module does not affect other modules.

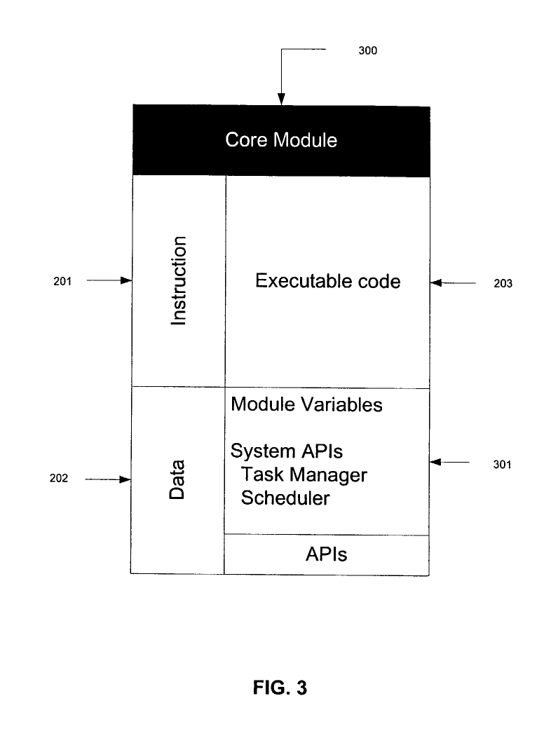

FIG. 3 is the structure of an exemplary core module 300. One of the core module 300's module variables 301 is System APIs (also referred to as a table), which stores the locations of other kernel modules' APIs. Other modules of the operating system store a pointer to point to the core module's table. If core module 300 is updated, then the other modules must be notified to update the System pointer to point to the new location of the System APIs variable.

With respect to the installation of a new or updated module, three events may trigger the installation. The installation may be triggered by an application of the computer system, by the operating system such as through the kernel, or by user input. For module updating, the following steps may occur. The new or updated module to be loaded is read into memory (if it is not already present in memory). The module links itself to the kernel data and initializes its necessary data. The old module may be unlinked and may be deleted from the kernel space. (See below for instances when the old module is not deleted).

In the exemplary embodiment, when the new or updated module is loaded into the kernel space, a function such as an initializeModule() function may be invoked with a pointer to the kernel data. In the initializeModule() function, the location of the module data is written to the global offset table, and the API structure is initialized and installed in the kernel data section. After initializing the module, other modules and applications have access to the module's APIs.

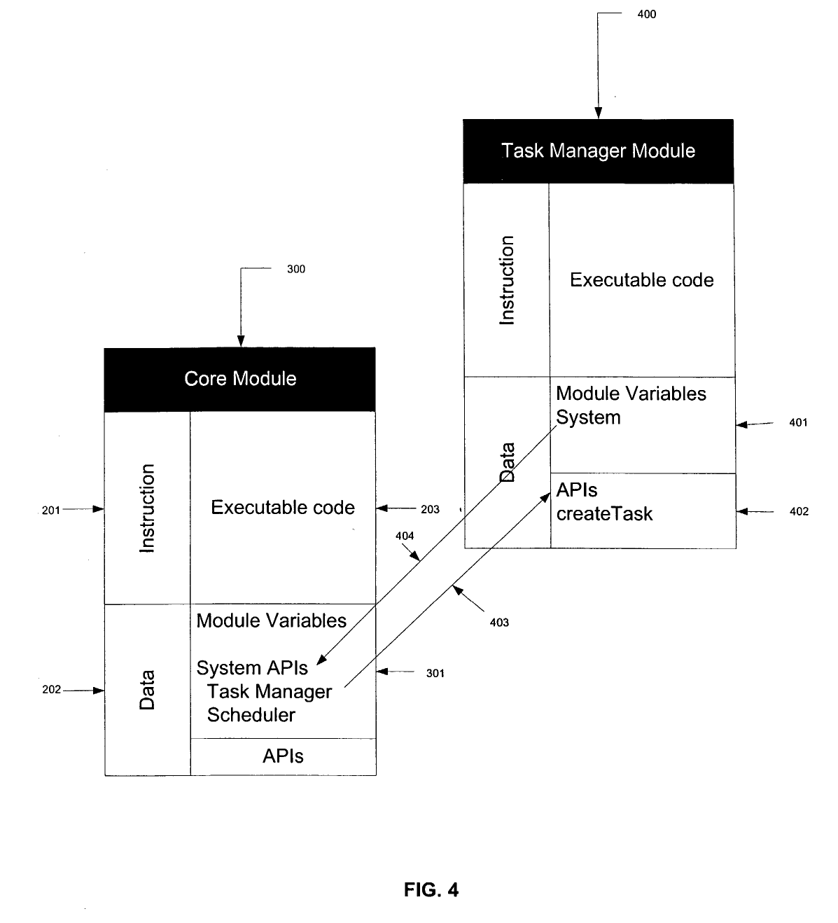

FIG. 4 represents an exemplary system after a task manager module 400 is installed in the operating system. The task manager module 400 installs the task manager module 400's APIs 402 in the core module 300's module variables 301 and stores the pointer to the system APIs in the task manager module 400's system data field in module variables 401. The task manager 400's APIs are available to other modules or applications. The arrow 403 signifies that the core module 300's task manager field points to the task manager APIs 402. The arrow 404 indicates that the task manager module 400's system variable points the core module 300's System APIs variable. When other modules are integrated into the operating system, the representation is similar to the that shown in FIG. 4.

A module of the operating system may need data or services of another kernel module. When such need is present, the appropriate API must be invoked. The module needing the data or services of another module is referred to as the “caller module”. To invoke the appropriate API, the caller module must obtain the location of the system APIs from the module data section 202 and the location of the target APIs. The system APIs are located in the data section 202 of the core module 300. The core module 300 data section 202 contains locations of all the modules' APIs. Each module updates the module's location in the system APIs and stores the location of the system APIs in the module data section 202. A kernel module can access others' APIs by referring to the system APIs. Accessing the new kernel module's data or services is done the same way as prior to the kernel module updating.

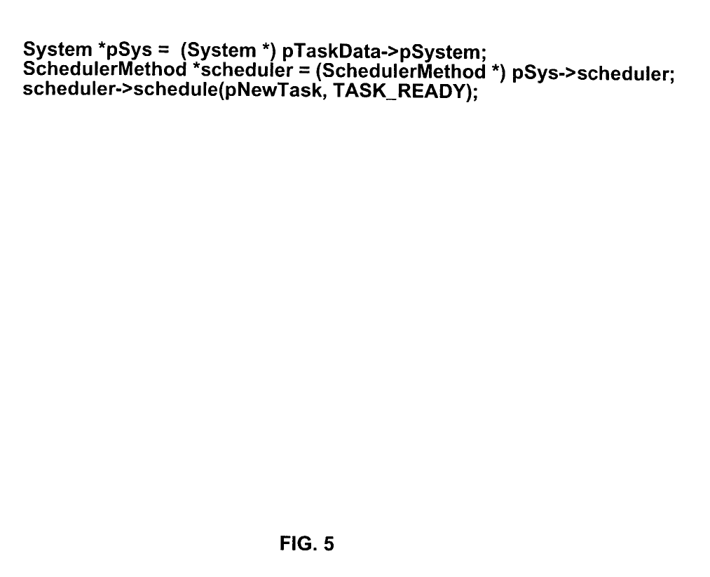

For example, if the task manager module 400 creates a task and invokes the scheduler API to schedule the task, the task manager module 400 may implements steps such as shown in FIG. 5. The steps may be as follows: First, the task manager module 400 can obtain the scheduler module APIs by using the System pointer. Second, the task manager obtains location of the System APIs variable in the core module, which stores the location of the scheduler module APIs. Finally, the task manager invokes the schedule API of the scheduler to schedule the task.

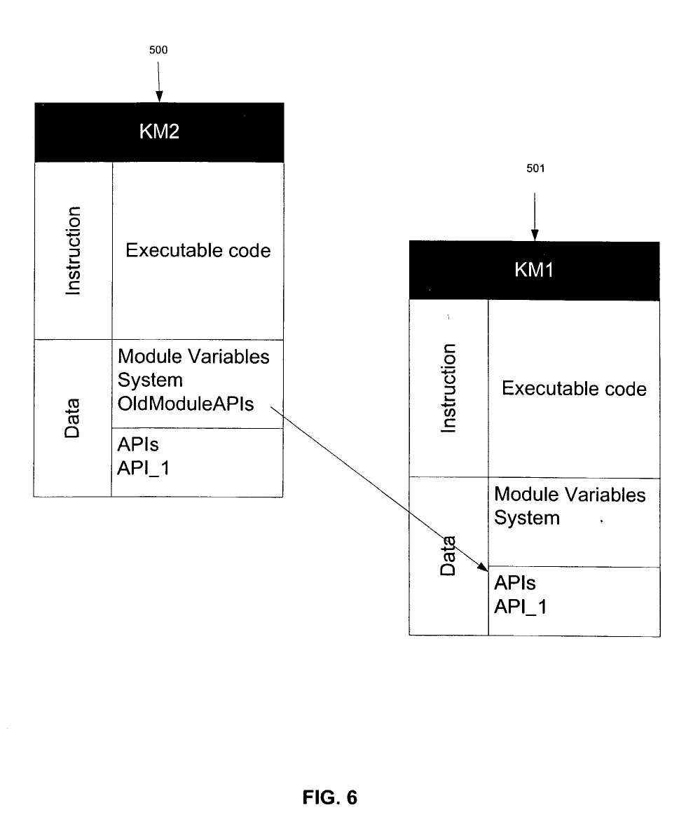

Advantageously, the updating of a kernel module is not limited to replacing the existing module with a new or updated module. The new or updated module can augment the existing module's functionalities by reusing the existing module's code and/or data. Therefore, the “old” kernel module still remains in memory. For instance, if the old kernel module does not implement error checking, the new or updated kernel module can install error-checking code and use the old kernel module's features. The old kernel module and the new or updated module can be cascaded. As illustrated in FIG. 6, KM2 500 is a new module, and KM1 501 is an existing module. When KM2 500 is requested to be integrated into the kernel, KM2 500 updates the pointer to point to KM2 500's module APIs and stores the location of the KM1 501's APIs in KM2 500's Module Variables section, “OldModuleAPIs” variable. The KM2 500's APIs can be a wrapper API for KM1 501's APIs. For example, when KM2 500's API_{—}1 is invoked, KM2 500's API_{—}1 can further invoke KM1 501's API_{—}1.

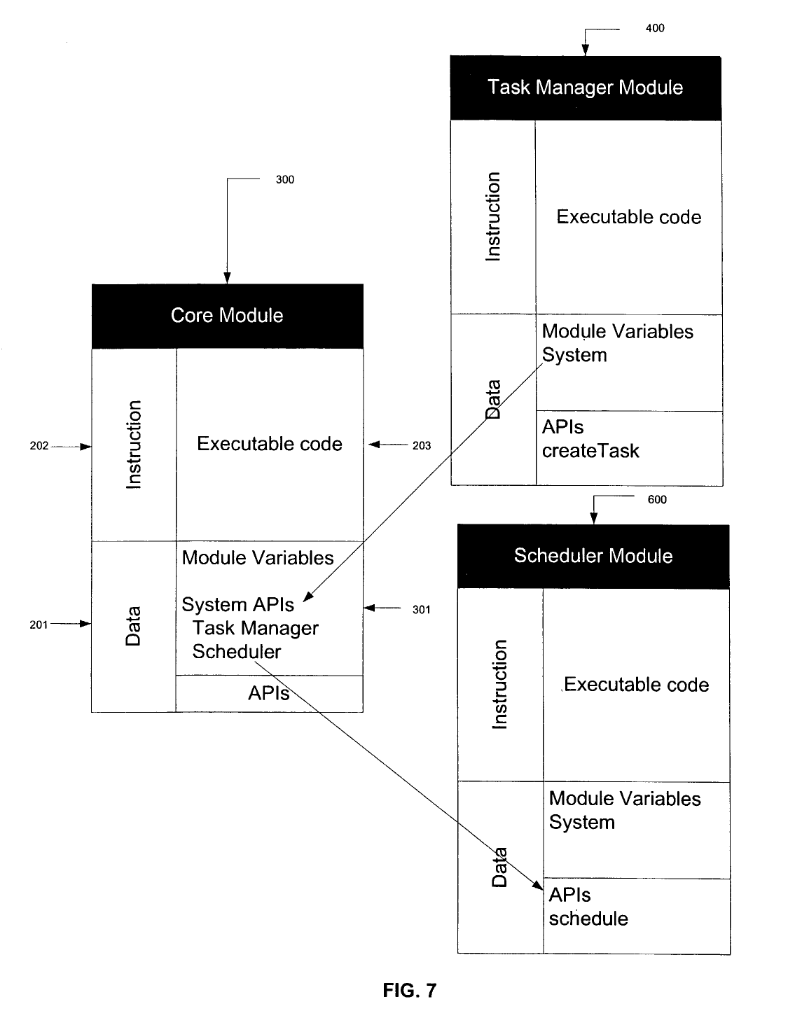

FIG. 7 shows an exemplary implementation for invoking an API. Since the task manager 400 has a pointer to the system APIs, the task manager 400 can invoke-standard scheduler 600 APIs such as schedules in constant time providing predictability. If the scheduler module 600 is updated, the updating process does not affect how the task manager 400 invokes the scheduler APIs—only how the core module 300 invokes the scheduler APIs is updated. This provides adaptability and flexibility in the RTOS by use of pointers.

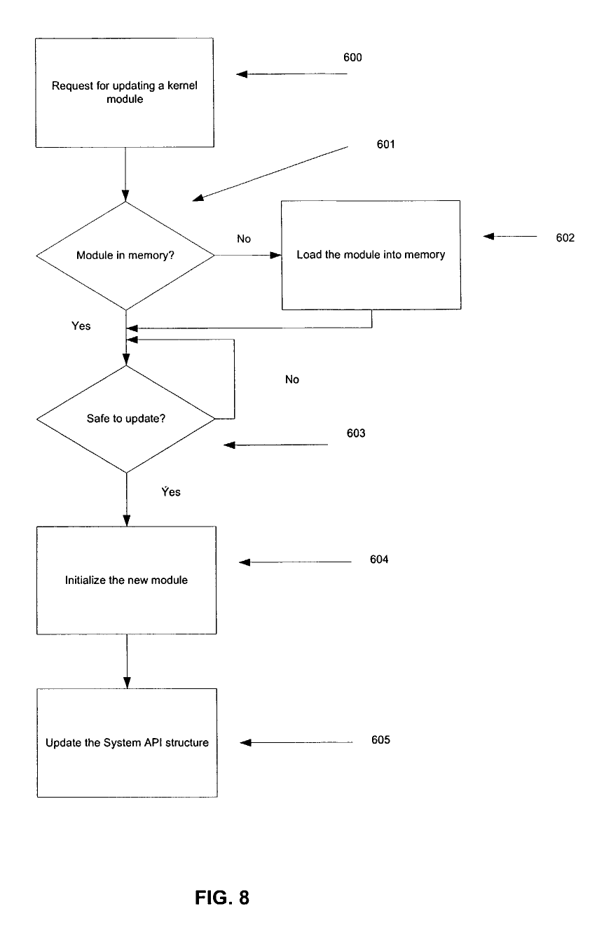

FIG. 8 is a flow chart representing exemplary actions or steps taken when the request for update of a kernel module occurs. When a request for an update of a kernel module 600 is received, the module loader checks 601 if the requested module is in memory. If the requested module is not in memory, the requested module is loaded into memory 602. When the requested module is in memory, the loader checks whether or not the current module is in a safe state for updating 603. If the current module is not in a safe state, the load will have a busy wait. Otherwise, the new module will be initialized 604. After initialization, the new module updates the System APIs structure 605 to contain a proper value of the address of the new module's API structure.

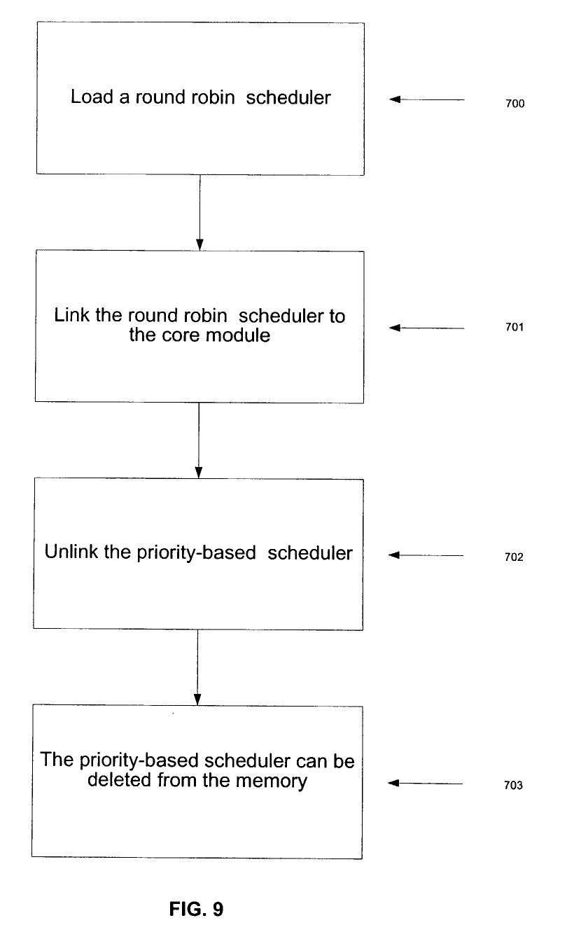

To further describe an exemplary embodiment, an example of a dynamic update to a scheduler module of an operating system is described. In this example, updating from one scheduler to another is illustrated. The update event may occur when a new or updated scheduler can manage tasks more efficiently than the current scheduler. If the new module is not already in the memory, the first step is to allocate memory space and load the module to this memory location. This process can be done in the background. FIG. 9 shows exemplary steps for switching from a priority-based scheduler to a round robin scheduler. This example assumes that the system is currently using a priority-based scheduler to manage the tasks, and a request for switching to round robin scheduler is made where the round robin scheduler module has already been loaded into memory 700.

The linking of the round robin scheduler to the core module 701 may consist of the following exemplary steps. The module loader invokes a function such as the initModule() API of the round robin scheduler to initialize variables. The round robin initModule() API is responsible for creating a ready queue and updating the scheduler entry in the system. Finally, initModule() initializes the timer with the round robin quantum and enables the timer to decrement. After the initialization, the scheduler entry in system APIs is changed to the round robin scheduler API 702, and the system is ready to operate using the round robin scheduler. Advantageously, other modules, which use the scheduler APIs, do not have to be updated. The priority-based scheduler can now be deleted from the system 703.

An example of the inventions is further provided by reference to an experiment running on an evaluation board. The first scheduler loaded is the priority-based scheduler. The switcher routine allocates memory space for the priority-based scheduler and returns a pointer to the beginning address of the allocated space. Then, the binary image of the priority-based scheduler module is loaded into this memory location. After the scheduler is initialized, the tasks mentioned in the paragraphs above are created and multitasking is started.

All of the tasks may work in loops. All of them, besides the idle task, may be suspended for a certain amount of time after finishing their respective jobs and before going into the next iteration of their respective loops. The three graphics-displaying tasks of the experiment have higher priority over task 4, the scheduler-changing task. From the simulation, when the highest priority task finishes its calculation and is suspended, the next highest priority task takes control of the CPU and starts to display its graphical data. The higher priority task, when it becomes ready again, preempts the lower priority graphics-displaying task. At some point, when all of the high priority graphics-displaying tasks are suspended, task 4 is scheduled to the CPU. Task 4, when it takes control of the CPU for the first time, calls the switcher routine to allocate memory space for the round-robin scheduler, to load the round-robin scheduler into the allocated memory, and to switch the scheduler. Then, task 4 is suspended until it gets active to change the scheduler for the next time.

After the round-robin scheduler is initialized and starts running, graphics-displaying tasks take turns during their computation. At this time, the three graphs are updated concurrently depending on the time slice of round-robin scheduler. Once both of the schedulers are loaded into memory, the switcher routine skips allocating memory space and loading the module's image. The switcher just changes the scheduler whenever the switcher is invoked by task 4.

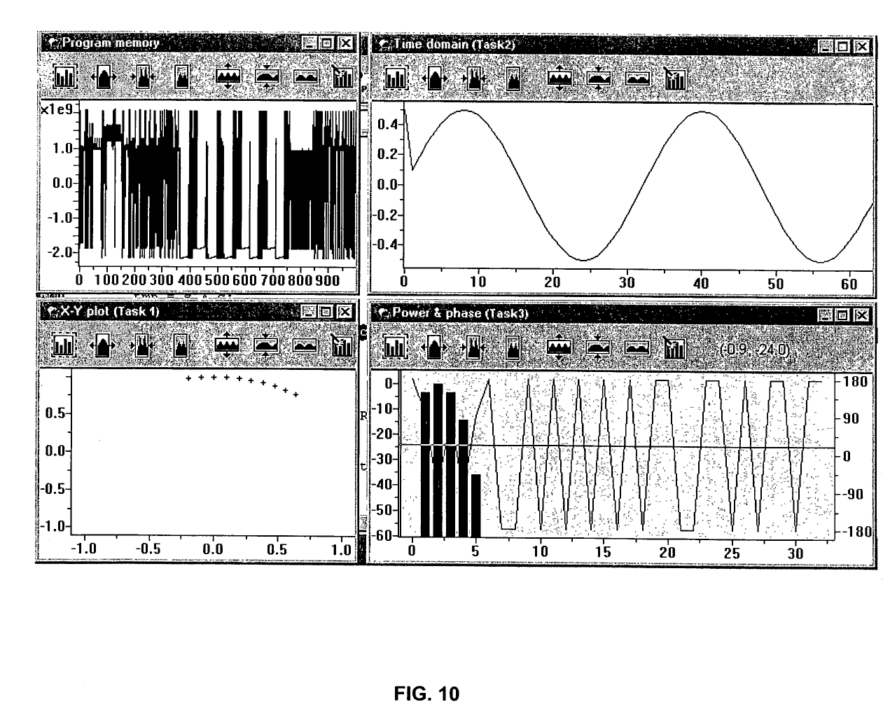

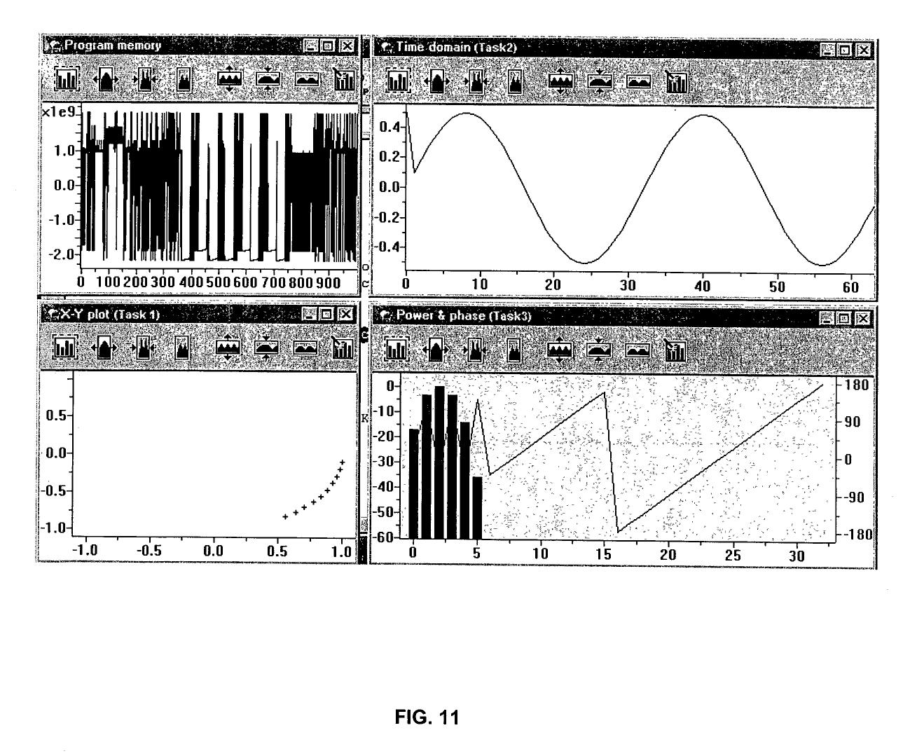

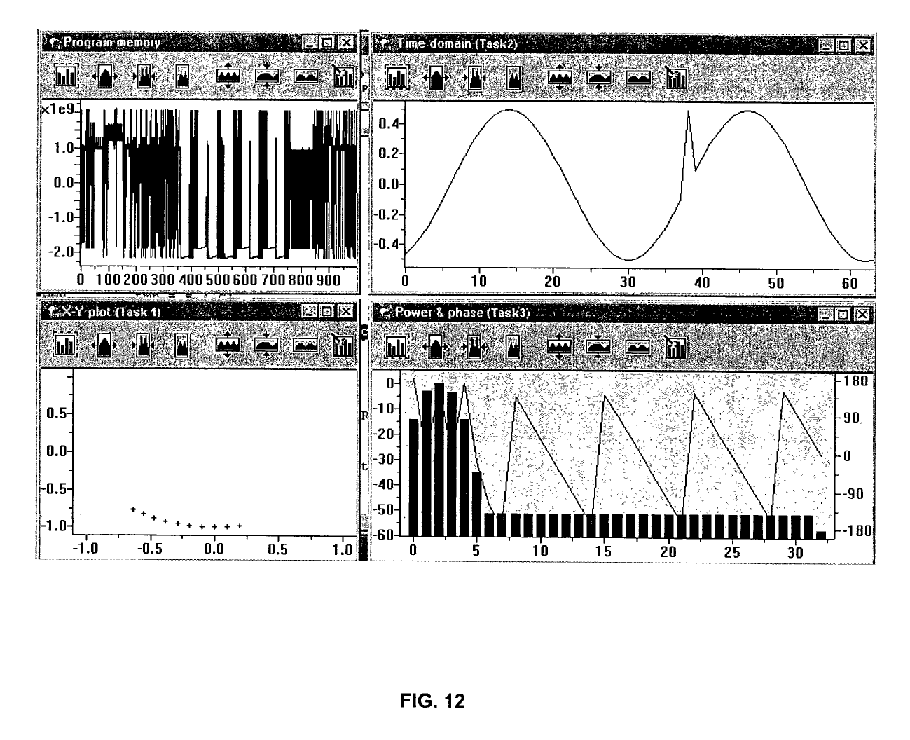

FIG. 10 shows a screenshot of the exemplary system running with a priority-based scheduler. Task 1 is currently running and updating the bottom-left graph while other tasks are suspended in the final phase of their computation. FIG. 11 shows that task 3 has been scheduled after both task 1 and task 2 had been suspended after finishing their drawing. Task 3 is drawing the bottom-right graph. Finally, FIG. 12 is a screenshot of the system working under a round-robin scheduler. As can be seen, all of the tasks are in the middle of their computation and are updating their corresponding graphs by taking turns.

An exemplary embodiment of the inventions may be used for a dynamic update of a loader module with a new loader module. When the system updates the loader module, the system calls the update API of the current loader module. The process for the loader module is similar to updating other modules with a minor exception. After the initModule() function of the new loader module is invoked, the new module replaces the old one. The initModule() function cannot return to the old loader module because the old loader module is unlinked. The return address from the initModule() function must be adjusted to the location that calls the update API of the old loader module. This is done by clearing the stack to ignore the call from the old loader module to the initModule() function of the new loader.

We claim:

1. In an operating system including a kernel with modules comprising a core module, a module unlinked to operation of the operating system, and other modules, a method to link the module to the operation of the operating system without affecting the other modules of the kernel, and without a reboot or a recompilation of the operating system, the method comprising:
causing the core module to include a table with each entry in the table respectively representing a location of at least an application program interface (API) of one of the other modules; and
linking the module to the core module by causing the module to initialize and to include a pointer to the table of the core module, and by causing the table of the core module to include an entry representing an address of at least an API of the module,
whereby the linking of the module to the core module links the module to the operation of the operating system,
whereby the other modules of the kernel are unaffected by the linking of the module to the operation of the operating system because the other modules are not provided with the address of the API of the module, and
whereby the reboot or recompilation of the operating system is unnecessary because the other modules of the kernel are unaffected by the linking of the module.

2. The method of claim 1, further comprising:
causing the other modules to have access to at least an API of the module by reference to the table of the core module.

3. The method of claim 2, wherein each of the other modules comprises the pointer to the table of the core module.

4. The method of claim 3, wherein each of the other modules references the table of the core module by using the pointer to the table of the core module.

5. The method of claim 1, wherein linking the module to the core module comprises loading the module into a memory.

6. The method of claim 1, further comprising:
causing the module to provide the core module with the address of at least an API of the module so the core module may include the address in the entry in the table.

7. In an operating system including a kernel with modules comprising a core module, a running module, and a new module, a method to update the operating system by substituting the new module for the running module, the method of updating comprising:
causing the core module to include a table with an entry in the table representing a location of at least an application program interface (API) of the running module; and
linking the new module to the core module by causing the new module to initialize and to include a pointer to the table of the core module, and by causing the table of the core module to substitute an address of at least an API of the new module for the location of at least the API of the running module.

8. The method of claim 7, further comprising deleting the running module.

9. The method of claim 7, further comprising:
cascading the new module and the running module.

10. The method of claim 9, wherein cascading the new module and the running module comprises causing the new module to invoke the running module when the new module is invoked.

11. The method of claim 7, further comprising:
causing the new module to store the location of at least an API of the running module.

12. The method of claim 7, further comprising:
causing the new module to provide the core module with the address of at least an API of the new module so the core module may make the substitution.

13. The method of claim 7, further comprising:
causing other modules of the kernel to have access to at least an API of the new module by reference to the table of the core module.

14. The method of claim 7, wherein linking the new module to the core module comprises loading the new module into a memory.

15. The method of claim 7, wherein the new module is linked to the core module in response to receipt of an indication to update the operating system with the new module.

16. The method of claim 7, further comprising:
loading the new module into a memory.

17. The method of claim 7, further comprising:
verifying safety of updating the operating system prior to linking the new module to the core module.

18. The method of claim 7, wherein each of the modules of the kernel includes the pointer to the table of the core module.

19. In an operating system including a kernel with modules comprising a core module, a method for a first module to invoke a second module, comprising:
causing the core module to include a table with an entry in the table representing a location of at least an application program interface (API) of the second module;
causing the first module to include a pointer to the table of the core module;
causing the first module to use the pointer to obtain the location of at least an API of the second module; and
causing the first module to use the location to access the second module.

20. The method of claim 19, wherein the second module includes the pointer to the table of the core module.
